(19) United States
(12) Patent Application Publication
(10) Pub. No.: US 2020/0217464 A1
(43) Pub. Date: Jul. 9, 2020

(54) SOLAR BRICK WITH MOVEMENT AND POSITION SENSING AND NFC-ENABLED COMMUNICATION CAPABILITIES

(71) Applicants: Hiram Tose Ticianelli, Coconut Creek, FL (US); Luigino Rigitano Netto, Piracicaba (BR); Marcelo Rodrigues, Piracicaba (BR)

(72) Inventors: Hiram Tose Ticianelli, Coconut Creek, FL (US); Luigino Rigitano Netto, Piracicaba (BR); Marcelo Rodrigues, Piracicaba (BR)

(73) Assignees: Hiram Tose Ticianelli, Coconut Creek, FL (US); Luigino Rigitano Netto, Piracicaba (BR); Marcelo Rodrigues, Piracicaba (BR)

(21) Appl. No.: 16/239,434

(22) Filed: Jan. 3, 2019

(51) Int. Cl. F21S 8/02; H02S 40/38; H02S 20/26; F21V 23/04; F24S 50/20; H04B 5/00; H05B 33/08; H02J 7/35

(52) U.S. Cl. CPC F21S 8/022; H02S 40/38; H02S 20/26; F21V 23/045; E04F 2290/026; H04B 5/0025; H05B 33/0806; H05B 33/0857; H02J 7/35; F24S 50/20

(57) ABSTRACT

A solar brick with a smart control system is provided with movement and position sensing and NFC-enabled communications capabilities. The smart control system of the solar brick enables the solar brick to be transported and installed beyond the conventional uses of a typical brick as the solar brick can be used and operated in walls, stairs, pools and other operational environments conceived by the user. The solar brick may include waterproof casing and harvests solar energy and converts it into electric energy by means of one or more internal photovoltaic cells. The use of renewable energy made possible by the solar brick is directed to environmental preservation. The smart control system of the solar brick comprises electronic circuitry embedded with a microcontroller which manages all operational and control functions and parameters of the solar, coupled to an electronic integrated circuit with an accelerometer which enables movement and position sensing of the solar brick, and an NFC interface circuit located in an NFC sensitive area for communication with a user. Auxiliary circuits may be controlled by the microcontroller and provide operational and control parameter information such as battery and photovoltaic cell charge and control the LEDs. The solar brick may have several mechanical formats to cater to the user's diverse needs. The NFC interface circuit located in the NFC sensitive area provides the user access to operational and control parameter information of the solar brick such as actual battery level, illumination mode and LED colors used. To access said information, the user may use an NFC-enabled communication mobile or specific device or may prefer to use a specific reader.

### FIELD OF INVENTION

The present invention refers to the field of solar bricks which are usually installed on the ground and/or walls with the purpose of illuminating at night from clean sunlight energy obtained during the day. The solar brick applications can vary from decorative purposes to safety signage.

### BACKGROUND OF THE INVENTION

The sun provides human kind with abundant clean and free energy. The number of devices using solar energy as a source of renewable and environment-friendly energy being developed is increasing at enormous pace. Using solar energy by means of an internal photovoltaic cell, a device generates electric energy. The electric energy generated is proportional to the level and strength of exposure to sunlight, with alternating power periods due to atmospheric conditions. The internal photovoltaic cell generates electric energy deriving from sunlight and the greater the luminous energy, the greater the electric power generated. The energy generated by the cell is managed by a microcontroller which transfers the energy to the internal batteries. The batteries have long shelf life with environmental preservation in mind so that they can be replaced in such a way that there is no need to dispose completely of the device.

Conventional solar bricks have for the most part simple operational capabilities limiting their scope of applications. Once installed, conventional solar bricks always function in the same way.

Likewise, conventional solar bricks are normally limited to floor use and configurations, such as driveways, parking lots, pool decks, walkways and patios, as their electronic and mechanical structural designs are conceived for floor use and configuration applications only. In addition, to avoid trouble during transportation, the conventional solar bricks are provided internally with circuitry including an electromechanical key which acts as a function of gravity. The function of the electromechanical key is to act as a battery energy switch. During transportation, the solar bricks are packaged and bundled with the side of the LEDs facing downwards. As a result of this placement during transportation, the electromechanical key powers the circuit off and prevents the battery from getting completely discharged. Finally, there is an additional problem during transportation which is the position of the casing of the solar brick inside the transportation vehicle being used. The position of the casing of the solar brick is not usually perceived and monitored and, as it turns out, when the solar brick is delivered, the solar brick's batteries have been completely discharged. In addition, on top to the problems generated by the solar brick battery discharge during transportation, conventional solar bricks also are disadvantageous in the sense that they can not be operated or used in inclined or vertical placement positions.

To avoid the shortcomings outlined above, a solar brick with a smart control system comprising a microcontroller including an NFC interface circuit was designed in such a way that the user can set up, configure and program the brick's operational capabilities by means of NFC-enabled communication for diverse operational and control settings even after it has been installed on the ground. The NFC standard (Near Field Communication) is a technology created for asset identification and provides for trackability and setup/configuration capabilities. NFC-enabled communication operates by bringing a reader, which can be a mobile or specific device, close to the solar brick using said technology. This technology is used to track animals, assets and currently is used to authenticate transactions carried out by means of a mobile device. NFC-enabled communications are made possible because each mobile or specific device has a unique identifier and because the NFC communication protocol holds resources that provide security.

NFC-enabled communications technology is based on the principle of remote device energization, in this case, energization of the solar brick, through the reader, in this case, the mobile or specific device. Once energized, the remote device sends data contained therein to the reader. The same excitation frequency energizing the remote device provides communication means between the two sides through a radio frequency enabled protocol. In the case of the solar brick, many operational and control parameters, such as the actual operating condition of the solar brick, can be sent to the reader and, through the reader, a user can reprogram or adjust the operating and control mode/conditions of the solar brick. For example, as one of the many of the resources, functions and advantages of the solar brick being able to be programmed and controlled, a user can set and adjust the solar brick for a particular and specific blocking position, color and luminosity intensity, time of luminosity/intensity, and functioning/operating and control status such as power level, programmed parameters, solar energy actual level, and internal temperature, inter alia.

Likewise, a solar brick with a smart control system comprising an accelerometer coupled to the microcontroller enables movement and position sensing which allows the solar brick to be powered off during transportation so as to prevent the batteries from being discharged in a particular transportation position. Likewise, the accelerometer component coupled to the microcontroller of the solar brick also allows the solar brick to be powered on and off, used and operated in different angles, beyond that of a horizontal position plane installation, such as in a vertical position or inclined position.

### SUMMARY OF THE INVENTION

A first object of the present invention is to provide a smart control system for a solar brick based on electronic circuitry embedded with a microcontroller including firmware and an NFC interface circuit located in an NFC sensitive area, the microcontroller coupled to an electronic integrated circuit with an accelerometer. Such structural electronic design and arrangement enables movement and position sensing status determination and function programming through a mobile or specific device for the solar brick. The smart control system for the solar brick also includes a LED driver that is coupled and controlled by the microcontroller and that is capable of setting or adjusting one or more technical functional and operating parameters of one or more RGB-type LEDs, and one or more RGB-type LEDs coupled and controlled by the LED driver in accordance to the one or more technical operating parameters set or adjusted through the mobile or specific device.

A second object of the present invention is to provide a solar brick comprising one or more photovoltaic cells capable of converting solar energy into electric energy; a photovoltaic circuit that is coupled to the one or more photovoltaic cells; one or more rechargeable batteries that are coupled to the photovoltaic circuit; an accelerometer that senses the movement and position of a solar brick; a microcontroller that is coupled to the accelerometer and fed with movement and position data of the solar brick from the accelerometer, the microcontroller includes firmware and an NFC interface circuit located in an NFC sensitive area which has NFC-enabled communication capabilities enabling status determination and function and operational programming of the solar brick through a mobile or specific device; a LED driver that is coupled and controlled by the microcontroller and that is capable of setting or adjusting one or more technical functional and operating parameters of one or more RGB-type LEDs; one or more RGB-type LEDs coupled and controlled by the LED driver in accordance to the one or more technical operating parameters set or adjusted through the mobile or specific device; and a casing that houses the one or more photovoltaic cells, the one or more rechargeable batteries, the photovoltaic circuit, the accelerometer, the microcontroller, the NFC interface circuit, the LED driver, and the one or more RGB-type LEDs.

A third object of the present invention is to provide an NFC interface-enabled communications method for a solar brick, comprising: determining status or function and operating programming of a solar brick by means of a microcontroller including firmware and an NFC interface circuit located in an NFC sensitive area, the microcontroller that is coupled to an accelerometer or a temperature sensor; feeding sensing, movement or temperature data obtained from the accelerometer or temperature sensor to the microcontroller; and setting or adjusting one or more technical functional and operating parameters through a mobile or specific device of one or more RGB-type LEDs that are coupled to a LED driver, the LED driver also coupled to the microcontroller.

### BRIEF DESCRIPTION OF THE DRAWINGS

FIG. 1 shows a schematic of a preferred embodiment of the smart control system and solar brick of the present invention.

FIG. 2 shows a top perspective view of one of the many embodiments of the smart control system and solar brick of the present invention.

FIG. 3 shows a bottom perspective view of one of the many embodiments of the smart control system and solar brick of the present invention.

FIG. 4 shows a top perspective view of one of the many embodiments of the smart control system and solar brick of the present invention.

FIG. 5 shows a bottom perspective view of one of the many embodiments of the smart control system and solar brick of the present invention.

FIG. 6 shows a top view of one of the many embodiments of the smart control system and solar brick of the present invention.

FIG. 7 shows a side view of one of the many embodiments of the smart control system and solar brick of the present invention.

FIG. 8 shows a top view of one of the many embodiments of the smart control system and solar brick of the present invention.

FIG. 9 shows a side view of one of the many embodiments of the smart control system and solar brick of the present invention.

### DETAILED DESCRIPTION OF THE INVENTION

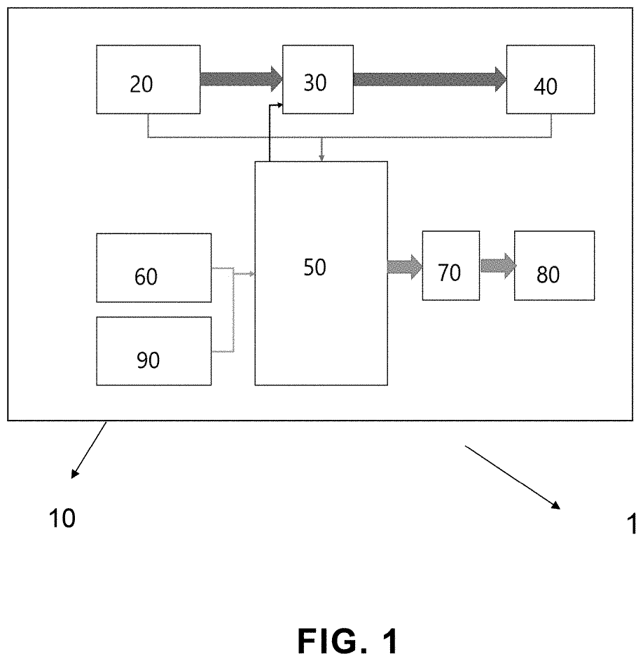

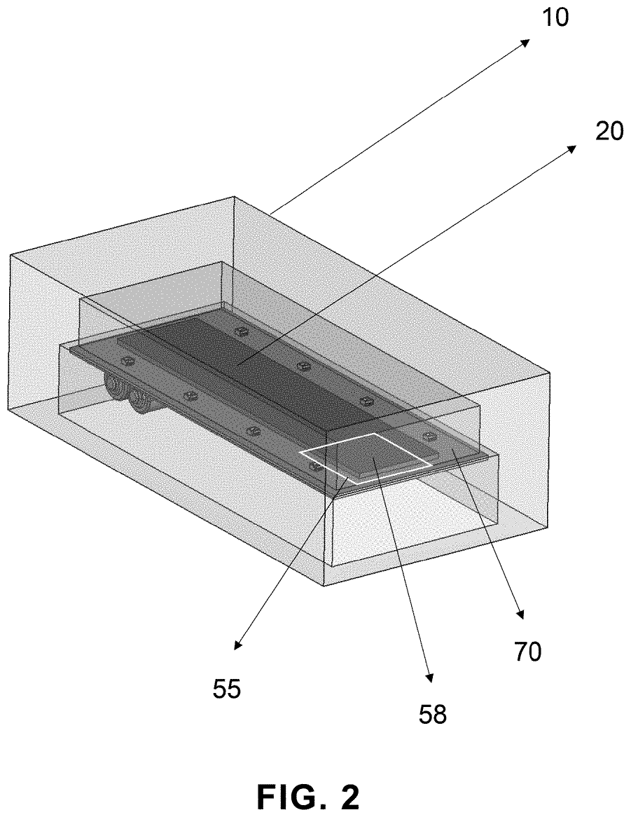

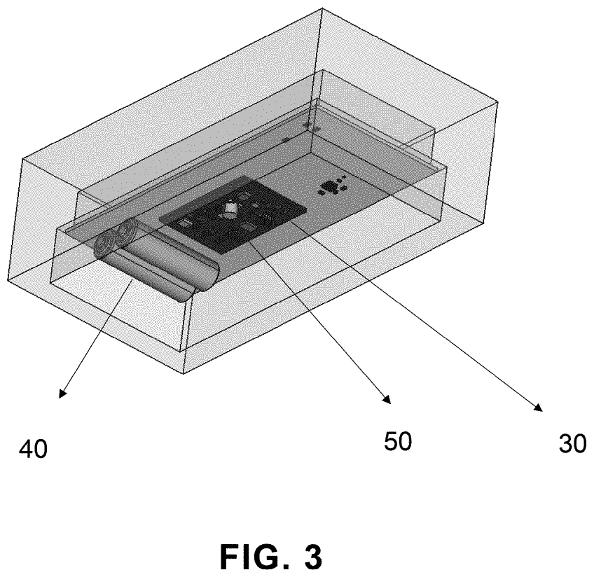

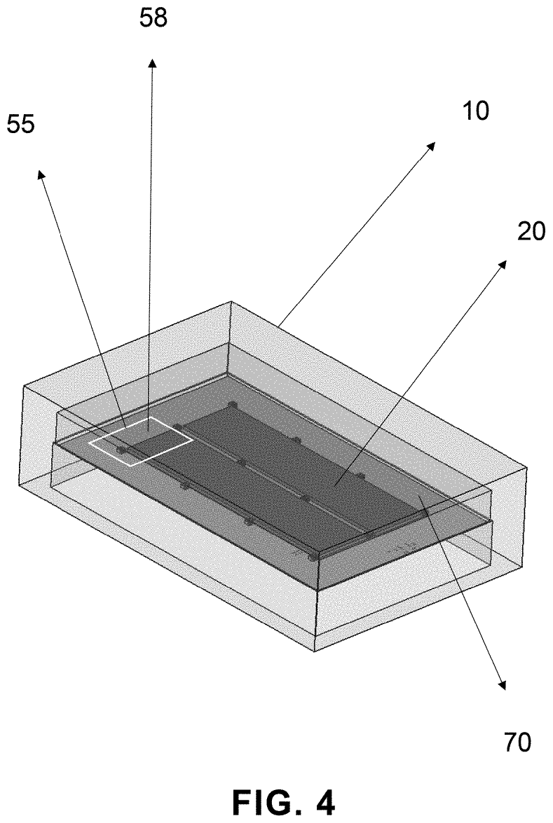

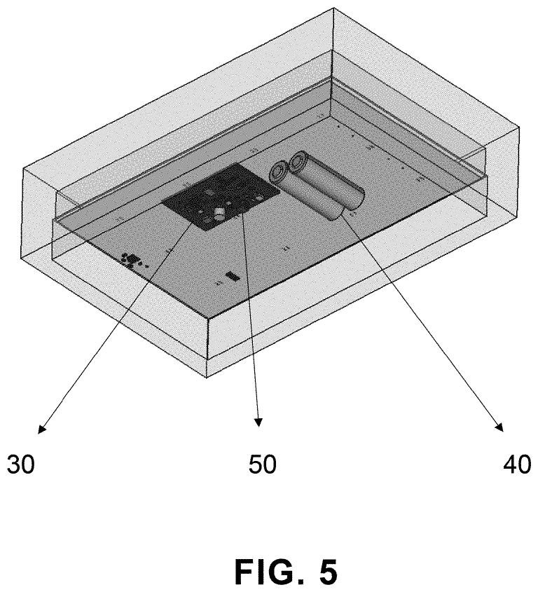

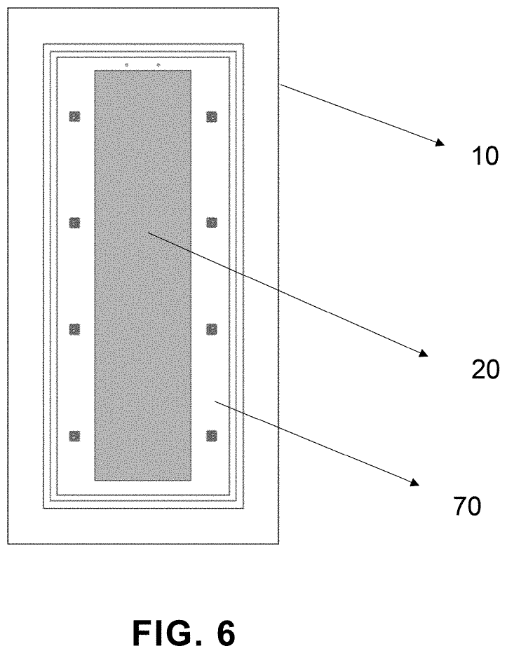

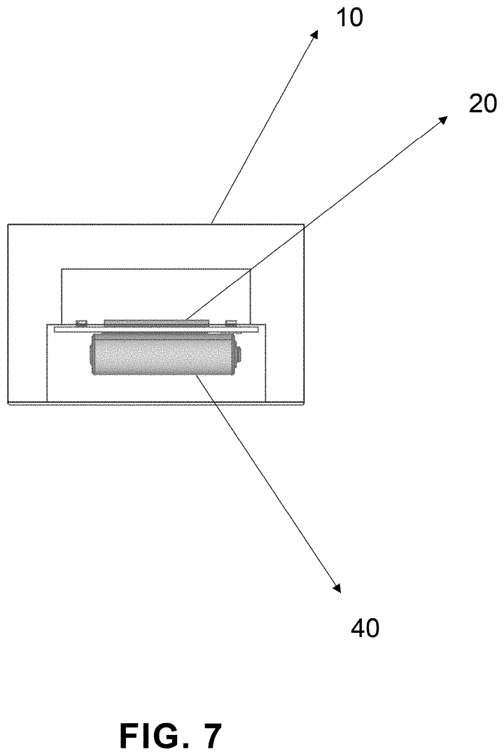

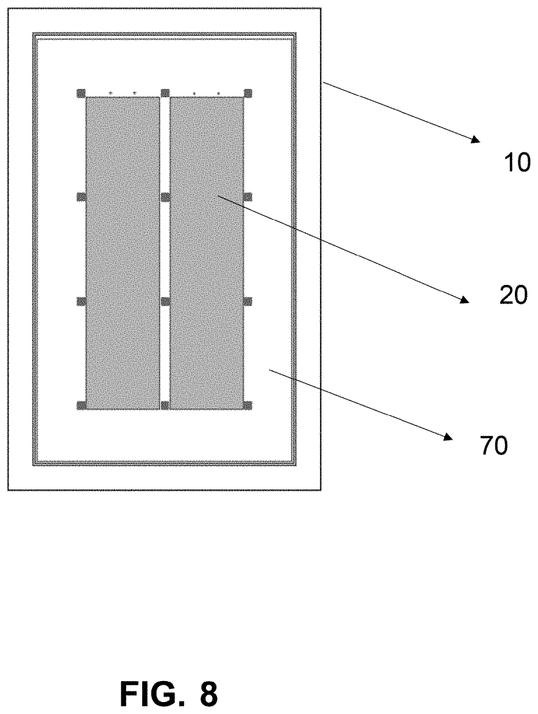

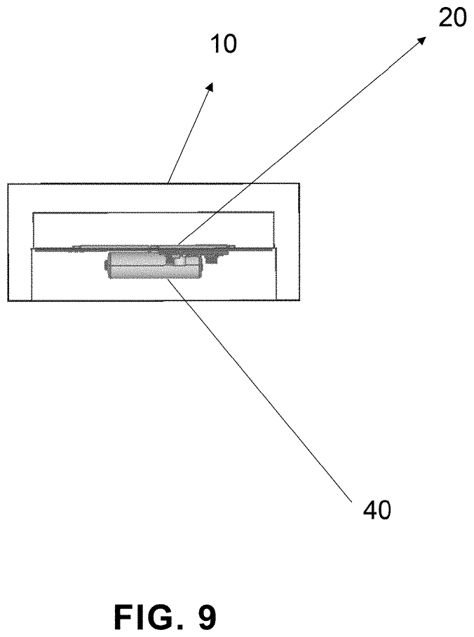

As shown in FIGS. 1 through 9, a smart control system for a solar brick 1 is sought to be protected by the present invention based on electronic circuitry embedded with a microcontroller 50 including firmware and an NFC interface circuit 58 located in an NFC sensitive area 55, and an electronic integrated circuit with an accelerometer 60. Such a structural electronic design and arrangement enables movement and position sensing and status determination and function programming through a mobile or specific device of the solar brick. The smart control system of the solar brick also includes a LED driver 70 that is coupled and controlled by the microcontroller 50 and that is capable of setting or adjusting one or more technical functional and operating parameters of one or more RGB-type LEDs 80, and one or more RGB-type LEDs 80 coupled and controlled by the LED driver 70 in accordance to the one or more technical operating parameters set or adjusted through the mobile or specific device.

The microcontroller 50 may include a 32-bit ARM microcontroller, but the microcontroller to be used by the smart control system may include any type of embedded communications, industrial or consumer device microcontroller.

The capabilities directed to movement and position sensing are possible because the electronic integrated circuit with the accelerometer 60 is coupled to the microcontroller 50. The position and movement sensing capabilities of the accelerometer 60 coupled to the microcontroller 50 allow the smart control system to power the solar brick on and off during transportation to prevent the batteries of the solar brick from being discharged in the typical horizontal transportation position. Likewise, the accelerometer 60 coupled to the microcontroller 50 of the solar brick 1 also allows the solar brick 1 to be used and operated in different angles, beyond that of a horizontal position plane installation, such as in a vertical position or inclined position.

Using the accelerometer 60 instead of a key preventing the operation and functioning of the solar brick 1 in a determined position, the microcontroller 50 tied to the accelerometer 60 determines the angular position of the solar brick 1. On top of the angular position, the accelerometer 60 is also able to determine if a casing 10 of the solar brick 1 has come to a complete stop or is moving, sensing if the brick is installed or being transported regardless of its position. With this novel design and arrangement, the shortcomings encountered in conventional solar bricks is overcome, regardless of the position of the solar brick 1, as the solar brick's configuration and arrangement senses if the solar brick 1 is being transported and can be used in different installation angles.

The accelerometer 60 may be a 3-axis accelerometer. The electronic integrated circuit of the accelerometer 60 may further be MEMS-technology based and may have internally 3 components that respond to and sense solar brick movement and position once installed in 3 possible axes X, Y and Z.

The component of the smart control system of the solar brick that enables it to operate the solar brick properly and effectively is its specific firmware. A firmware is a software specifically developed for a hardware component which, in this case, is for and found in the microcontroller 50. The firmware is the one component which possesses the information related to the ideal battery charge level of the solar brick 1 and its operation and control capabilities, as well as how much energy can be obtained from a photovoltaic solar cell and the best operation mode.

The solution found and embedded in the firmware may be an algorithm using Maximum Power Point Tracking (MPPT), which is a computational technique which is usually found only at the hardware level in a conventional solar brick. In the smart control system of the solar brick of the present invention, the MPPT algorithm is found and embedded in the firmware. In addition, the MPPT algorithm is conditioned and used for other operating and control parameters and factors such as actual battery energy level, making it a much more efficient solution.

The NFC interface circuit 58 located in the NFC sensitive area 55 included in the microcontroller 50 provides the user access to operational and control parameter information of the solar brick 1 such as actual battery level, illumination mode and LED colors used. To access said information, a user may use an NFC-enabled communication mobile or specific device or may prefer to use a specific reader.

By having NFC-enabled communication capabilities, the smart control system of the solar brick 1 allows the operation of the solar brick 1 to be customized after installing the solar brick 1 in a horizontal, vertical or inclined position. The user can, through its smart control system, configure the solar brick and adjust its operational mode/conditions to cater to different environments or different situations such as social events, special dates, to highlight architectural contours or even act as safety/emergency lighting.

Another common factor in conventional solar bricks is the white color lighting/illumination or any other chosen lighting/illumination color. More specifically, conventional solar bricks have fixed colors as the user operates these conventional solar bricks always with the same fixed color provided by the manufacturer. The smart control system of the solar brick 1 of the present invention overcomes the previous shortcomings as it has RGB-type LEDs. The RGB-type LEDs have 3 components or internal LEDs, one for each color being: red, green and blue. The RGB-type LEDs can be powered independently generating the 3 primary colors or with modulated power in each of the primary colors enabling possibly a great number of color schemes and several resulting white shades.

In another embodiment of the smart control system of the solar brick of the present invention, the smart control system may include a temperature sensor 90 that is coupled to the microcontroller 50 and is capable of feeding the microcontroller 50 with temperature data of the solar brick.

As shown in FIGS. 1 through 9, a solar brick 1 with movement, position sensor and NFC communication capabilities is provided and sought to be protected, the solar brick 1 comprising one or more photovoltaic cells 20 capable of converting solar energy into electric energy; a photovoltaic circuit 30 that is coupled to the one or more photovoltaic cells 20; one or more rechargeable batteries 40 that are coupled to the photovoltaic circuit 30; an accelerometer 60 that senses the movement and position of the solar brick; a microcontroller 50 that is coupled to the accelerometer 60 and fed with movement and position data of the solar brick 1 from the accelerometer 60, the microcontroller 50 includes firmware and an NFC interface circuit 58 located in an NFC sensitive area 55 and which has NFC-enabled communication capabilities enabling status determination and function and operational programming of the solar brick through a mobile or specific device; a LED 70 driver that is coupled and controlled by the microcontroller 50 and that is capable of setting or adjusting one or more technical functional and operating parameters of one or more RGB-type LEDs 80; one or more RGB-type LEDs 80 coupled and controlled by the LED driver 70 in accordance to the one or more technical operating parameters set or adjusted through the mobile or specific device; and a casing 10 that houses the one or more photovoltaic cells 20, the one or more rechargeable batteries 40, the photovoltaic circuit 30, the accelerometer 60, the microcontroller 50 including the firmware and the NFC interface circuit 58 located in the NFC sensitive area 55, the LED driver 70, and the one or more RGB-type LEDs 80.

In different embodiments of the solar brick of the present invention, the solar brick 1 may include one or more high endurance rechargeable batteries. Likewise, the casing 10 of the solar brick 1 may be waterproof and completely sealed. In addition, the casing 10 of the solar brick 1 may be made of durable glass which is resistant to vehicular traffic. Similarly, the casing 10 may also be made of translucid polymers (like, but not limited to, polycarbonate, polyethylene, polypropylene), resins, foam, fiberglass, natural stone, quartz, inter alia.

In another embodiment of the solar brick of the present invention, the solar brick 1 may include a temperature sensor 90 that is coupled to the microcontroller 50 and is capable of feeding the microcontroller 50 with temperature data of the solar brick 1.

The solar brick 1 and its smart control system are compatible with, but not limited to, operating systems such as Android and iPhone, can be coupled easily to a PC or laptop, and all of its status parameters can be visualized such as power level, programmed parameters, solar energy actual level, internal temperature, inter alia. With exposure to sunlight, the one or more photovoltaic cells 20 generate energy which is managed by the microcontroller 50 for charging the one or more rechargeable batteries 40 in accordance with its functional and operational limits.

After sundown, the smart control system of the smart brick 1 powers the LEDs 80 automatically with colors and the operation mode programmed by the user. By means of smart management, the lighting/illumination power is proportional to the charge harvested/obtained during the day.

All operational information and functioning possibilities about the solar brick 1 are made available to the user by the means of the NFC interface circuit 58 located in the NFC sensitive area 55 and the firmware. The NFC interface circuit 58 located in the NFC sensitive area 55 and the firmware enables the user through the mobile or specific device to obtain current information about the operational and control conditions of the solar brick 1 which can be read and to program the operation mode.

Different embodiments of the solar brick 1 may comprise one or more photovoltaic cells, one or more rechargeable batteries, but the electronic circuitry of the photovoltaic cells, microcontroller, NFC interface circuit and accelerometer may or may not be the same for all embodiments. The firmware may also be adapted for specific operating conditions or configuration setups.

The main purpose and advantage of the solar brick 1 and its smart control system of the present invention is to be able to use the solar brick 1 to highlight pedestrian walkways, safety overpass lanes, architectural contours, inter alia, beyond its conventional uses such as in driveways, parking lots, pool decks, walkways and patios.

An NFC interface-enabled communications method for a solar brick is also provided and sought to be protected comprising: determining status or function and operating programming of a solar brick 1 by means of a microcontroller 50 including firmware and an NFC interface circuit 58 located in an NFC sensitive area 55, the microcontroller 50 that is coupled to an accelerometer 60 or a temperature sensor 90; feeding sensing, movement or temperature data obtained from the accelerometer 60 or temperature sensor 90 to the microcontroller 50; and setting or adjusting one or more technical functional and operating parameters through a mobile or specific device of one or more RGB-type LEDs 80 that are coupled to a LED driver 70, the LED driver 70 also coupled to the microcontroller 50.

With all of the advantages and novelties outlined and advanced above in the solar brick 1, its smart control system and NFC interface-enabled communications method of the present invention, architects may enjoy great flexibility in developing architectural projects which can greatly change the luminous appearance of the projects in accordance with diverse and different client needs.

What is claimed is:

1. A smart control system with position and movement sensing and NFC-enabled communications capabilities for a solar brick, comprising:
an accelerometer that senses the movement and position of a solar brick;
a microcontroller that is coupled to the accelerometer and fed with movement and position data of the solar brick from the accelerometer, the microcontroller includes firmware and an NFC interface circuit located in an NFC sensitive area and which has NFC-enabled communication capabilities enabling status determination and function and operational programming of the solar brick through a mobile or specific device;
a LED driver that is coupled and controlled by the microcontroller and that is capable of setting or adjusting one or more technical functional and operating parameters of one or more RGB-type LEDs; and
one or more RGB-type LEDs coupled and controlled by the LED driver in accordance to the one or more technical operating parameters set or adjusted through the mobile or specific device.

2. A smart control system of claim 1, further comprising a temperature sensor that is coupled to the microcontroller and is capable of feeding the microcontroller with temperature data of the solar brick.

3. The smart control system of claim 1, wherein the accelerometer is capable of powering up and down the solar brick based on the sensing of the movement or position of the solar brick and allows the solar brick to be operated or used in inclined or vertical placement positions.

4. The smart control system of claim 1, wherein the accelerometer is a 3-axis accelerometer and has internally 3 components that respond to and sense solar brick frame movement and position once installed in 3 possible axes X, Y and Z, wherein the microcontroller may include a 32-bit ARM microcontroller or any type of embedded communications, industrial or consumer device microcontroller, and wherein the RGB-type LEDs have 3 components or internal LEDs, one for each color being: red, green and blue, the RGB-type LEDs can be powered independently generating the 3 primary colors or with modulated power in each of the primary colors enabling possibly a great number of color schemes and several resulting white shades.

5. The smart control system of claim 1, wherein the firmware is embedded with one or more specific algorithms which monitor the solar brick position and movement by data fed by accelerometer, and which enables status determination and functional and operational programming of the solar brick by data fed from the NFC interface circuit located in the NFC sensitive area through the mobile or specific device.

6. The smart control system of claim 5, wherein the firmware may be embedded with an algorithm using Maximum Power Point Tracking (MPPT).

7. The smart control system of claim 1, wherein the microcontroller manages the energy generated by one or more photovoltaic cells being exposed to sunlight, the energy charging one or more rechargeable batteries in accordance with their operational limits.

8. A solar brick with movement, position sensor and NFC communication capabilities, comprising:
one or more photovoltaic cells capable of converting solar energy into electric energy;
a photovoltaic circuit that is coupled to the one or more photovoltaic cells;
one or more rechargeable batteries that are coupled to the photovoltaic circuit;
an accelerometer that senses the movement and position of a solar brick;
a microcontroller that is coupled to the accelerometer and fed with movement and position data of the solar brick from the accelerometer, the microcontroller includes firmware and an NFC interface circuit located in an NFC sensitive area and which has NFC-enabled communication capabilities enabling status determination and function and operational programming of the solar brick through a mobile or specific device;
a LED driver that is coupled and controlled by the microcontroller and that is capable of setting or adjusting one or more technical functional and operating parameters of one or more RGB-type LEDs;
one or more RGB-type LEDs coupled and controlled by the LED driver in accordance to the one or more technical operating parameters set or adjusted through the mobile or specific device; and
a casing that houses the one or more photovoltaic cells, the one or more rechargeable batteries, the photovoltaic circuit, the accelerometer, the microcontroller, the NFC interface circuit, the LED driver, and the one or more RGB-type LEDs.

9. The solar brick of claim 8, further comprising a temperature sensor that is coupled to the microcontroller and is capable of feeding the microcontroller with temperature data of the solar brick.

10. The solar brick of claim 8, wherein the accelerometer is capable of powering up and down the solar brick based on the sensing of the movement or position of the solar brick and allowing the solar brick to be operated or used in inclined or vertical placement positions.

11. The solar brick of claim 8, wherein the accelerometer is a 3-axis accelerometer and has internally 3 components that respond to and sense solar brick frame movement and position once installed in 3 possible axes X, Y and Z, wherein the microcontroller may include a 32-bit ARM microcontroller or any type of embedded communications, industrial or consumer device microcontroller, wherein the RGB-type LEDs have 3 components or internal LEDs, one for each color being: red, green and blue, the RGB-type LEDs can be powered independently generating the 3 primary colors or with modulated power in each of the primary colors enabling possibly a great number of color schemes and several resulting white shades, and wherein the casing may be made of translucid polymers, resins, glass, foam, fiberglass, natural stone, quartz, inter alia.

12. The solar brick of claim 8, wherein the firmware is embedded with specific algorithms which monitor the solar brick position and movement by data fed by accelerometer, and which enables status determination and functional and operational programming of the solar brick by data fed from the NFC interface circuit located in the NFC sensitive area through the mobile or specific device.

13. The solar brick of claim 12, wherein the firmware may be embedded with an algorithm using Maximum Power Point Tracking (MPPT).

14. The solar brick of claim 8, wherein the microcontroller manages the energy generated by one or more photovoltaic cells being exposed to sunlight, the energy charging one or more rechargeable batteries in accordance with their operational limits.

15. A NFC interface-enabled communications method for a solar brick, comprising:
determining status or function and operating programming of a solar brick by means of a microcontroller including firmware and an NFC interface circuit located in an NFC sensitive area, the microcontroller that is coupled to an accelerometer or a temperature sensor;
feeding sensing, movement or temperature data obtained from the accelerometer or temperature sensor to the microcontroller; and
setting or adjusting one or more technical functional and operating parameters through a mobile or specific device of one or more RGB-type LEDs that are coupled to a LED driver, the LED driver also coupled to the microcontroller.

16. The NFC-interface enabled communications method of claim 15, wherein the microcontroller is coupled to a photovoltaic circuit that is coupled to one or more rechargeable batteries and one or more photovoltaic cells capable of converting solar energy into electric energy, and wherein the microcontroller manages the energy generated by the one or more photovoltaic cells being exposed to sunlight, the energy charging one or more rechargeable batteries in accordance with their operational limits.

17. The NFC-interface enabled communications method of claim 15, wherein the accelerometer is capable of powering up and down the solar brick based on the sensing of the movement or position of the solar brick and allowing the solar brick to be operated or used in inclined or vertical placement positions.

18. The NFC-interface enabled communications method of claim 15, wherein the accelerometer is a 3-axis accelerometer and has internally 3 components that respond to and sense solar brick frame movement and position once installed in 3 possible axes X, Y and Z, wherein the microcontroller may include a 32-bit ARM microcontroller or any type of embedded communications, industrial or consumer device microcontroller, and wherein the RGB-type LEDs have 3 components or internal LEDs, one for each color being: red, green and blue, the RGB-type LEDs can be powered independently generating the 3 primary colors or with modulated power in each of the primary colors enabling possibly a great number of color schemes and several resulting white shades.

19. The NFC-interface enabled communications method of claim 15, wherein the firmware is embedded with specific algorithms which monitor the solar brick position and movement by data fed by accelerometer, and which enables status determination and functional and operational programming of the solar brick by data fed from the NFC interface circuit located in the NFC sensitive area through the mobile or specific device.

20. The NFC-interface enabled communications method of claim 19, wherein the firmware may be embedded with an algorithm using Maximum Power Point Tracking (MPPT).
